(19) United States
(12) Patent Application Publication
(10) Pub. No.: US 2008/0304515 A1
(43) Pub. Date: Dec. 11, 2008

(54) COMMUNICATION SYSTEM AND COMMUNICATION METHOD

(76) Inventor: YASUTAKA MAEDA, Shizuoka (JP)

Correspondence Address: NEC CORPORATION OF AMERICA, 6535 N. STATE HWY 161, IRVING, TX, 75039, US

(21) Appl. No.: 12/055,657

(22) Filed: Mar. 26, 2008

(30) Foreign Application Priority Data
Mar. 29, 2007 (JP) 88018/2007

(51) Int. Cl. H04J 3/22

(52) U.S. Cl. 370/466

(57) ABSTRACT

A communication system includes a transmitting unit transmitting a packet data and a receiving unit receiving a packet data. The transmitting unit includes a first detection unit receiving a packet data transmitted using a first protocol, detecting a predetermined bit pattern in the received packet data, and determining the packet data in which the bit pattern is detected is a target of protocol conversion; and a first converting unit converting the first protocol of the determined packet data into a second protocol including a retransmission function, adding a tag indicating the protocol conversion to the converted packet data and transmitting the converted data. The receiving unit includes a second detection unit receiving the packet data transmitted using the second protocol and detecting the tag; and a second converting unit converting the protocol of the packet data in which the conversion tag is detected into a third protocol.

This application is based upon and claims the benefit of priority from Japanese patent application No. 2007-088018, filed on Mar. 29, 2007 the disclosure of which is incorporated herein in its entirety by reference.

### BACKGROUND OF THE INVENTION

1. Technical Field

The present invention relates to a communication system and a communication method. In particular, the present invention relates to a communication system and a communication method which can reduce degradation of communication quality in spite of lack and/or delay of packets in packet communications.

2. Background Art

G3-facsimile is a standard of a facsimile defined in ITU-T (Telecommunication Standardization Sector of International Telecommunication Union) Recommendation T.30. Japanese Patent Application Laid-Open No. 2005-057505 discloses a related art of the communication system that the signal of image data is transmitted and received between G3-facsimile terminals using an IP (Internet Protocol) telephone network. In the technology above-described, the image signal is treated as an audio signal. When the image signal is transmitted and received via the IP telephone network, lack and/or delay of packets may occur, which do not occur in a communications via a public telephone network, may occur, and therefore communication via the IP telephone network quality may deteriorate remarkably.

An IP telephone service uses an IP network. The IP telephone service provided by an IP telephone service provider (hereinafter, referred to as an IP telephone network) may include two types of networks. One network includes only a private network of the IP telephone service provider. The other network includes a private network and the Internet. In the private network, the IP telephone service provider manages the packets in the private network. Therefore, when only the private network is used, in order to reduce lack and/or delay of packets, the IP telephone service provider can provide predetermined QoS (Quality of Service) to transmitted packets. As the means to provide the QoS, for example, an RSVP (Resource Reservation Protocol) is known. The RSVP is defined in RFC2205 of IETF (Internet Engineering Task Force). On the other hand, since all data are equally transmitted in the internet basically, the service provider cannot manage IP telephone packets in the internet. For this reason, in service via the internet, since the QoS of data cannot be secured, degradation of the communication quality due to the lack and/or delay of the packet may occur.

In RTP (Real-Time Transport Protocol) which is a protocol usually used in the IP telephone service, a real-time feature is quite important compared with reliability of communications. Thus, lost packets and/or delayed packets are ignored when data is received. That is, even if the lack and/or delay of packets occur in the IP telephone network, the packets are not resent in RTP. Thereby, when packets are lost and/or delayed, the communication quality may be degraded in RTP.

In a voice communication, small voice degradation caused by lack and/or delay of the packets is allowable. However, in an image communication, when the lack and/or delay of the packets occur in the IP telephone network, original images cannot be correctly restored. Such feature becomes a fatal disadvantage when the image communication is performed in the IP telephone network.

In the image communication using the IP telephone network, an image signal is treated as an audio signal like the image communication using the public telephone network.

However, in the IP telephone network, it is difficult to secure QoS of packets passing through the Internet. Even if packet loss occurs, the packets are not resent in RTP. Thus, the IP telephone network includes a disadvantage for securing a quality of the image communication.

Japanese Patent Application Laid-Open No. 2006-121176 describes a related art of the communication system which includes a gateway for improving facsimile communication quality. The gateway includes a buffer which holds received packets. The buffer holds packets to equalize arrival times of the packets. When a facsimile terminal receives the packets, the gateway makes length of the buffer longer than that of voice call. The gateway restores digital audio data from the packets read from the buffer. The gateway restores image information from the restored digital audio data. A preamble included in the restored image information is extended by a predetermined number of times or by a predetermined period of time. The preamble is a flag sequence (a bit pattern as “01111110”) of HDLC (High-level Data Link Control Procedure) protocol. The image information is transmitted to the facsimile terminal. Thus, in the technology disclosed in Japanese Patent Application Laid-Open No. 2006-121176, the gateway requires addition of new functions such as a function for varying the length of the buffer, and a preamble extension function.

Japanese Patent Application Laid-Open No. 2000-278473 discloses a related art of the communication system which includes a facsimile data transmission method via an IP network. The facsimile data transmission method includes following procedures,

(1) Converting an address from a telephone number of a receiving side facsimile terminal, to which a transmitting side facsimile terminal transmits at a time of setting a call, to a corresponding IP address,

(2) Requiring TCP (Transmission Control Protocol) connection to a relay apparatus which relays data to the IP address, upon reception of a recognition signal which indicates a transmission of a facsimile data from the transmitting side facsimile terminal,

(3) Transmitting the facsimile data to the relay apparatus using the TCP connection.

### SUMMARY

An exemplary object of the invention is to provide a communication system and a communication method which can improve communication quality in a packet communication.

A communication system according to an exemplary aspect of the invention includes a transmitting unit transmitting a packet data including a first detection unit receiving a packet data transmitted using a first protocol not including a retransmission function, detecting a predetermined bit pattern in the received packet data, and determining the packet data in which the bit pattern is detected is a target of protocol conversion; and a first converting unit converting the first protocol of the determined packet data into a second protocol including a retransmission function, adding a conversion tag indicating execution of the protocol conversion to the converted packet data and transmitting the converted packet data including the conversion tag; and a receiver; and a receiving unit for receiving a packet data including a second detection unit receiving the packet data which is transmitted using the second protocol and detecting the conversion tag in the packet data which is transmitted using the second protocol; and a second converting unit converting the protocol of the packet data in which the conversion tag is detected into a third protocol.

A communication method according to an exemplary aspect of the invention includes receiving a packet data transmitted using a first protocol not including a retransmission function,

detecting a predetermined bit pattern in the packet data received, determining the packet data in which the bit pattern is detected is a target of protocol conversion, converting the protocol of the determined packet data into a second protocol including a retransmission function, adding a conversion tag indicating execution of the protocol conversion to the converted packet data and transmitting the converted packet data including the conversion tag, receiving the packet data transmitted using the second protocol, detecting the conversion tag in the packet data transmitted using the second protocol and converting the protocol of the packet data in which the conversion tag is detected into a third protocol.

A transmitting unit according to an exemplary aspect of the invention includes a detection unit receiving a packet data transmitted using a first protocol not including a retransmission function, detecting a predetermined bit pattern in the received packet data, and determining the packet data in which the bit pattern is detected is a target of protocol conversion, and a converting unit converting the first protocol of the determined packet data into a second protocol including a retransmission function, adding a conversion tag indicating execution of the protocol conversion to the converted packet data and transmitting the converted packet data including the conversion tag.

A transmission method according to an exemplary aspect of the invention includes receiving a packet data transmitted using a first protocol not including a retransmission function, detecting a predetermined bit pattern in the packet data received, determining the packet data in which the bit pattern is detected is a target of protocol conversion, converting the protocol of the determined packet data into a second protocol including a retransmission function, and adding a conversion tag indicating execution of the protocol conversion to the converted packet data and transmitting the converted packet data including the conversion tag.

A receiving unit according to an exemplary aspect of the invention includes a detection unit receiving packet data which is transmitted using a first protocol including a retransmission function and detecting a conversion tag in the packet data which is transmitted using the first protocol, and a converting unit converting the protocol of the packet data in which the conversion tag is detected into a second protocol not including a retransmission function.

A receiving method according to an exemplary aspect of the invention includes receiving packet data transmitted using a first protocol including a retransmission function, detecting a conversion tag in the packet data transmitted using the first protocol, and converting the protocol of the packet data in which the conversion tag is detected into a second protocol not including a retransmission function.

A control program according to an exemplary aspect of the invention includes a control program for executing a function of the transmitter in a control unit thereof.

### BRIEF DESCRIPTION OF THE DRAWINGS

Exemplary features and advantages of the present invention will become apparent from the following detailed description when taken with the accompanying drawings in which:

FIG. 1 is a diagram showing a configuration of a first exemplary embodiment of a communication system of the present invention;

FIG. 2 is a diagram showing an HDLC frame format of a G3-FAX image signal defined in ITU-T Recommendation T.30;

FIG. 3 is a diagram showing packet formats of a UDP packet and a TCP packet converted from the UDP packet;

FIG. 4 is a diagram showing a packet processing procedure in the BAS 13;

FIG. 5 is a diagram showing a packet processing procedure in the BAS 23; and

FIG. 6 is a diagram showing a second exemplary embodiment of the present invention.

### EXEMPLARY EMBODIMENT

Exemplary embodiments of the present invention will now be described in detail in accordance with the accompanying drawings.

### 1. First Exemplary Embodiment

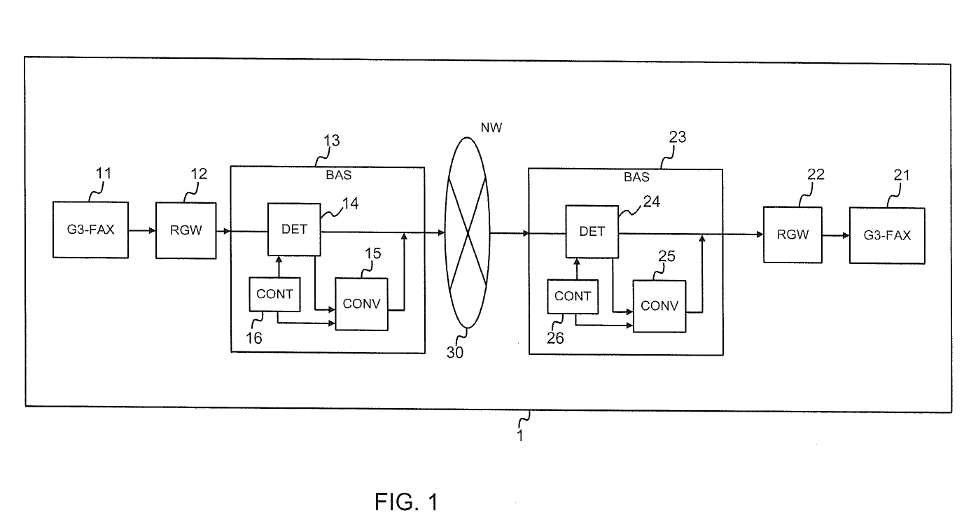

FIG. 1 shows a configuration of a first exemplary embodiment of a communication system of the present invention. In a communication system 1, facsimile image signal is processed as an audio signal and data communication is performed among G3-facsimile terminals using an IP telephone network.

As shown in FIG. 1, the communication system 1 includes G3-facsimile terminals (G3-FAXs) 11 and 21, residential gateways (RGWs) 12 and 22, broadband access servers (BASs) 13 and 23, and an IP telephone network (NW) 30. The BASs are installed in communications equipment room of a service provider to perform authentication of users and control connection with a network. The G3-FAX 11 is connected with the BAS 13 via the RGW 12. The G3-FAX 21 is connected with the BAS 23 via the RGW 22. The BASs 13 and 23 are connected with each other via the IP telephone network 30.

In an exemplary embodiment below, a facsimile image signal is transmitted from the G3-FAX 11 to the G3-FAX 21. The G3-FAX 11 is a G3-facsimile terminal based upon the ITU-T Recommendation T.30. The RGW 12 performs an analog to digital conversion (hereinafter, referred to as A/D conversion) of an image signal received from the G3-FAX 11. Since the RGW 12 processes the image signal as a audio signal, the image signal after performing the A/D conversion is regarded as a digital audio data. The RGW 12 loads the digital data formed by the A/D conversion into an RTP packet used in an IP telephone, and transmits the digital data to the NW 30. More in detail, the RTP packet is a UDP (User Datagram Protocol) packet which includes the RTP packet. The format of the RTP packet is described below.

The G3-FAX 21 is a G3-FAX based upon ITU-T Recommendation T.30. The RGW 22 performs a digital to analogue conversion (hereinafter, referred to as D/A conversion) of the RTP packet received from the NW 30 and reproduces an audio signal. The D/A conversion is performed according to a procedure opposite of the A/D conversion in the RGW 12. The RGW 22 transmits the reproduced audio signal to the G3-FAX 21.

The G3-FAXs 11 and 21, and the RGWs 12 and 22 includes functions similar to functions of usual FAXs and RGWs, respectively. On the other hand, the BASs 13 and 23 have new functions. The functions of the BASs 13 and 23 are described below.

The BAS 13 receives an RTP packet transmitted by the RGW 12. The BAS 13 has a function of a usual BAS. Further, the BAS 13 includes a detecting unit (DET) 14, a conversion unit (CONV) 15 and a control unit (CONT) 16. The DET 14 analyzes the RTP packet and identifies that the RTP packet includes image signal when a preamble is detected in the HDLC (High-level Data Link Control procedure) frame of the image data. The preamble is a bit-pattern in which a flag sequence of the HDLC such as “01111110” continues. The DET 14 recognizes that the image data starts at the detection part of the flag sequence. The CONV 15 converts a protocol of the RTP packet from UDP into TCP. Moreover, the CONV 15 appends, to the TCP packet, a conversion tag which indicates that protocol conversion from UDP to TCP is performed in the BAS 13. The control unit (CONT) 16 monitors and controls operations of the DET 14 and the CONV 15.

The TCP can retransmit a missing packet by checking a sequence of packets. On the other hand, UDP does not have such a retransmission function. Thus, if a protocol is converted from UDP into TCP, reliability of data transmission improves.

The BAS 23 has a function of a usual BAS. Further, the BAS 23 includes a detecting unit (DET) 24 and a conversion unit (CONV) 25. The DET 24 detects a TCP packet including the conversion tag. The CONV 25 deletes the conversion tag from the detected TCP packet and converts the protocol of the packet to UDP from TCP. The control unit (CONT) 26 monitors and controls operations of the DET 24 and the CONV 25.

The above description is an explanation about transmitting the image signal from the BAS 13 to the BAS 23. Bidirectional image transmission between G3-FAXs 11 and 21 obviously becomes possible when an apparatus having both functions of the BAS 13 and the BAS 23 is utilized.

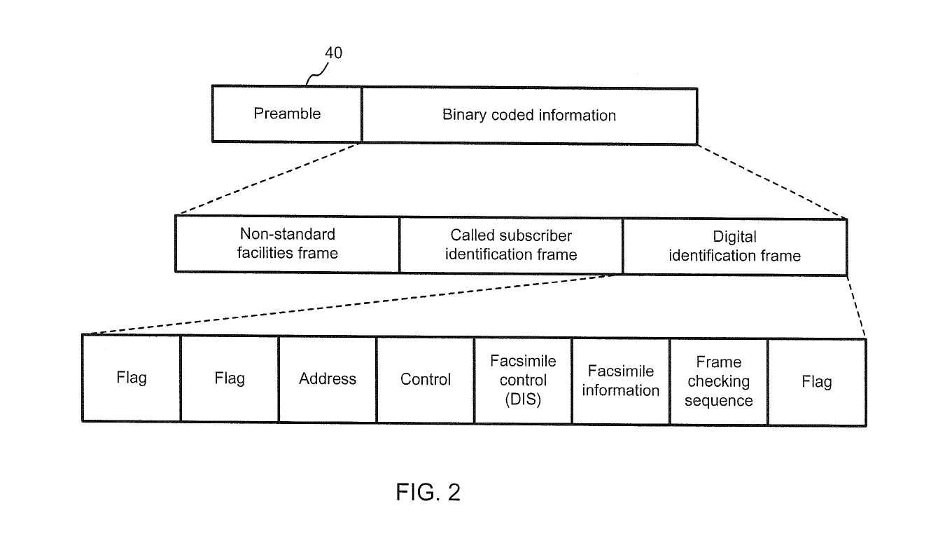

FIG. 2 shows an HDLC frame format of G3-FAX image signal defined in ITU-T Recommendation T.30. The HDLC frame includes a preamble 40. The preamble 40 is located at a head of the HDLC frame and is a trailer part for clock synchronization. In ITU-T Recommendation T.30, the preamble 40 is defined as consecution of a “01111110” pattern that is a flag sequence of the HDLC protocol. Duration of the preamble 40 is set as 1 second ±15%. In the first exemplary embodiment, the DET 14 of the BAS 13 identifies whether or not image signal is included in data using the preamble 40.

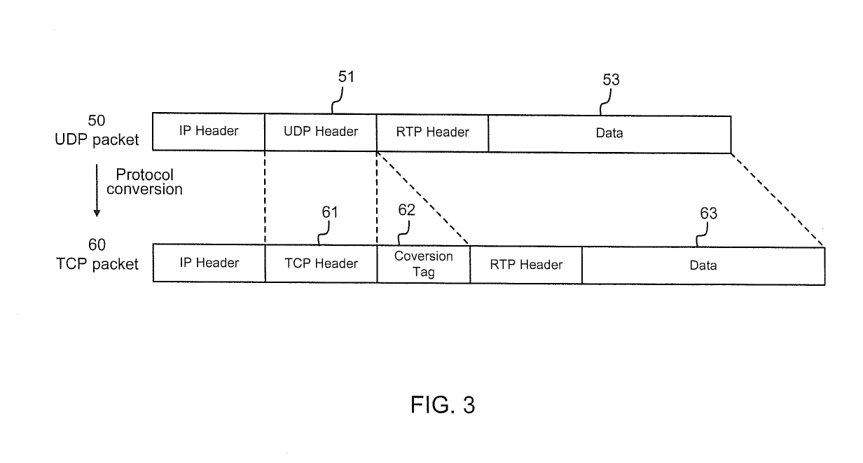

FIG. 3 shows packet formats of a UDP packet and a TCP packet converted from the UDP packet. The procedures of protocol conversion by the CONV 15 of the BAS 13 are described below referring to FIG. 3. The CONV 15 converts a UDP header 51 of a UDP packet 50 into a TCP header 61. Moreover, the CONV 15 appends to a TCP packet 60 a conversion tag 62 which indicates that a protocol conversion is performed.

The HDLC frame including the preamble 40 in a part thereof is stored in a data 53 of the UDP packet as shown in FIG. 3. When the DET 14 receives the UDP packet 50 with RTP, the DET 14 analyzes the data 53 included therein. When analyzing the data 53 to detect the preamble 40, the DET 14 determines image signal starts at the position.

An operation of the communication system 1 according to the exemplary embodiment is described with reference to FIGS. 1-3. Here, a facsimile communication between the G3-FAX 11 and the G3-FAX 21 is performed by treating image signal as an audio signal.

The G3-FAX 11 takes in image signal. The G3-FAX 11 performs digital modulation of the image signal. The G3-FAX 11 transmits the digital-modulated image signal to the RGW 12 as an audio signal. A frame structure of the image signal is the HDLC frame shown in FIG. 2.

The RGW 12 performs A/D conversion of the digital-modulated image signal. The image signal is processed as an audio signal during the A/D conversion. The digital data generated by the A/D conversion is transmitted to the BAS 13 according to RTP which is used in IP telephone protocol. The RGW 12 transmits the RTP packet using the UDP packet shown in FIG. 3.

The DET 14 in the BAS 13 analyzes the UDP packet 50 received from the RGW 12. The data 53 included in the UDP packet 50 includes the HDLC frame. The HDLC frame includes the preamble 40 shown in FIG. 2. When detecting the preamble 40 in the data 53, the DET 14 recognizes the position where the preamble is detected as start position of the image signal. The CONV 15 performs protocol conversion to convert the UDP packet 50 into the TCP packet 60 after detecting start position of the image signal. FIG. 3 shows packet configurations of the UDP packet and the TCP packet after performing the protocol conversion. The CONV 15 appends, to the TCP packet 60, the conversion tag 62 which indicates that the protocol conversion is performed in the sending BAS 13. The Data 53 included in the UDP packet is stored in a data area of the TCP packet 60 as a data 63. The BAS 13 transmits the resultant TCP packet 60 to the IP telephone network 30.

The TCP packet 60 transmitted by the BAS 13 reaches the BAS 23 via the IP telephone network 30.

The BAS 23 receives the packet transmitted by the BAS 13. The DET 24 detects the TCP packet 60 to which the conversion tag 62 is appended. When the conversion tag 62 is included in the received TCP packet 60, the DET 24 recognizes that the TCP packet 60 is generated through the protocol conversion by the CONV 15. When the TCP packet 60 includes the conversion tag 62, the CONV 25 deletes the conversion tag 62 from the TCP packet 60. After that, the CONV 25 performs the protocol conversion to convert the TCP packet 60 to the UDP packet 50. The BAS 23 transmits the UDP packet 50 to the RGW 22.

The RGW 22 performs D/A conversion of the received UDP packet 50 and restores the image signal. The D/A conversion is performed according to a procedure opposite of the A/D conversion. The RGW 22 transmits the image signal to the G3-FAX 21 as an audio signal.

The G3-FAX 21 restores an image using the image signal received from the RGW 22.

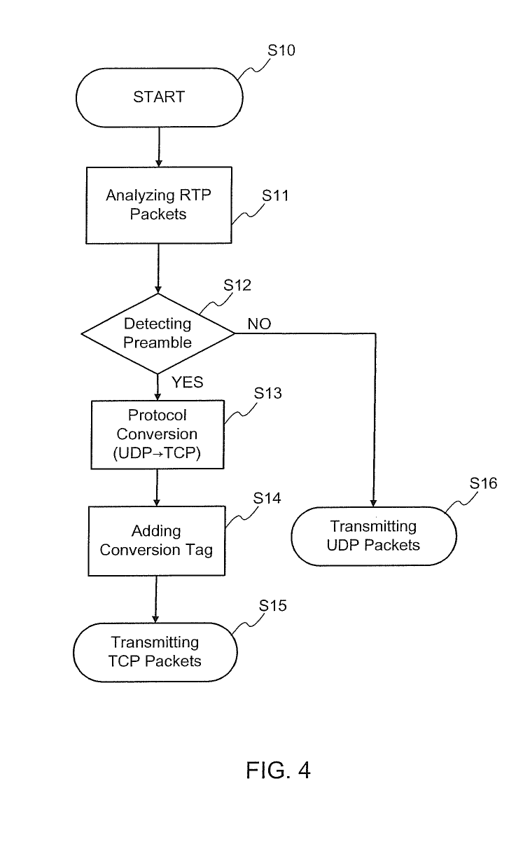

FIG. 4 shows packet processing procedures in the BAS 13. The SIP (Session Initiation Protocol) for starting an IP telephone session installed in the BAS 13 establishes an IP communication between the G3-FAX 11 and the G3-FAX 21.

When communication between the G3-FAX 11 and the G3-FAX 21 starts (Step S10), the DET 14 of the BAS 13 analyzes the RTP packets (UDP packet 50) received from the RGW 12 (Step S11). The DET 14 confirms whether or not the preamble 40 is included in the UDP packet 50 (Step S12). When the DET 14 detects the preamble 40 (step S12; Yes), the CONV 15 converts the UDP packet 50 into the TCP packet 60 (Step S13). Moreover, the CONV 15 appends the conversion tag 62 to the TCP packet 60 (Step S14). The BAS 13 transmits the converted TCP packets 60 to the IP telephone network 30 (Step S15).

On the other hand, when the preamble 40 is absent in the UDP packet 50 (Step S12; No), the DET 14 recognizes the UDP packet 50 as an audio call packet through on a usual telephone. Then the BAS 13 transmits the UDP packets to the IP telephone network 30 without any processing (Step S16).

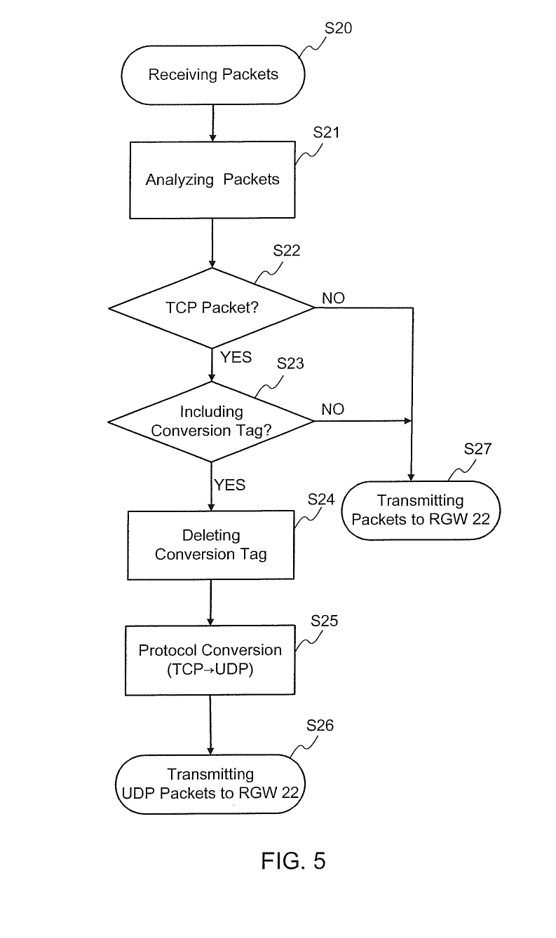

FIG. 5 shows packet processing procedures in the BAS 23. A receiving side needs to consider three kinds of entering packets as follows. That is, the packets are (1) TCP packet 60 which is generated through protocol conversion in the BAS 13, (2) UDP packet 50 of a usual audio call, and (3) TCP packet of the other data communications such as a SIP.

The DET 24 of the BAS 23 receives a packet (Step S20) and analyzes the received packet (Step S21). The DET 24 determines whether or not the received packet is a TCP packet (Step S22). When the received packet is the TCP packet (step S22; Yes), the DET 24 determines whether or not the TCP packet includes the conversion tag 62 (Step S23). When the TCP packet includes the conversion tag 62 (step S23; Yes), the TCP packet is a packet of the image signal generated through the protocol conversion in the BAS 13. The CONV 25 deletes the conversion tag 62 from the TCP packet 60 (Step S24). Moreover, the CONV 25 converts the TCP packet 60 into the UDP packet 50 (Step S25). The BAS 23 transmits the UDP packet 50 to the RGW 22 (Step S26).

On the other hand, when the received packet is not the TCP packet (step S22; No), the BAS 23 transmits the packet to the RGW 22 without performing a protocol conversion (Step S27). When the TCP packet does not include the conversion tag 62 (step S23; No), the BAS 23 transmits the TCP packet to the RGW 22 without performing a protocol conversion (Step S27).

According to the first exemplary embodiment described above, when image signal is transmitted through the IP telephone network using the TCP instead of the UDP, reliability deterioration caused by lack and/or delay of packets can be reduced. In other words, the TCP improves tolerability for the lack and/or delay of the packet during passing the IP telephone network. As a result, communication quality of the image signal becomes stable, and reliability of communication improves.

Moreover, a communication method between the G3-FAX and the BAS according to the exemplary embodiment described above can employ a usual communication method. In a transmitting side and a receiving side, it is unnecessary to add a new function to the G3-FAX and the RGW. Therefore, a user can employ a G3-FAX which is currently used and can employ the communication system of the present invention at low cost. An IP telephone service provider needs to only add a new function according to the present invention to a BAS and does not need to change functions of equipment installed in user's premises. The IP telephone service provider can employ the communication system of the present invention at low cost.

When the G3-FAX and/or the RGW which are installed in a user's premises has a failure, an IP telephone service provider may call at the user's premises for investigation thereof. According to the exemplary embodiment mentioned above, in a section between the RGW and the BAS, SIP or RTP is used for an IP telephone and a TCP or the like is used for a data communication. The protocols are well-known protocols for an IP telephone service provider. On the other hand, the protocol conversion function used in the exemplary embodiment mentioned above is used only between BASs of an IP telephone service provider. Therefore, in a maintenance work about the protocol conversion function, it is not necessary to visit at a user's premises. Only operations in the BAS which is equipment of an IP telephone service provider are needed. Therefore, the IP telephone service provider can perform maintenance thereof at low cost after an employment of the communication system of the present invention.

### 2. Second Exemplary Embodiment

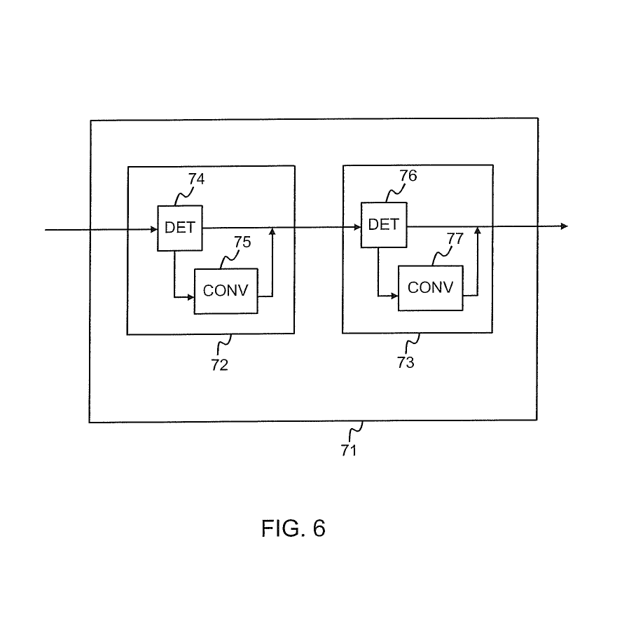

FIG. 6 illustrates a second exemplary embodiment of the present invention. The second exemplary embodiment is built with the elements indispensable to the present invention. In FIG. 6, a communication system 71 of the second exemplary embodiment includes a transmitter 72 and a receiver 73. The transmitter 72 includes a first detecting unit (DET) 74 and a first conversion unit (CONV) 75, and the receiver 73 includes a second detecting unit (DET) 76 and a second conversion unit (CONV) 77.

The transmitter 72 receives a packet transmitted according to a protocol not including a retransmission function. The first DET 74 detects a predetermined bit pattern in a data area of the packet and determines whether or not the detected packet is a target of protocol conversion. The first CONV 75 converts the protocol of the packet determined as a target of the protocol conversion into a protocol having a retransmission function. The first CONV 75 appends a conversion tag which indicates that the conversion is performed to the converted packet.

The receiver 73 receives the packet which the transmitter 72 transmits. The second DET 76 detects the packet including the conversion tag. The second CONV 77 converts the protocol of the packet including the conversion tag into a protocol not including a retransmission function.

That is, the communication system 71 equipped with a configuration shown in FIG. 6 includes the transmitter 72 and the receiver 73. The transmitter 72 detects presence or absence of a predetermined bit pattern in the packet transmitted by the protocol not including the retransmission function. When the predetermined bit pattern is detected, the transmitter 72 converts the protocol of the packet into the protocol having the retransmission function. Next, the transmitter 72 adds the conversion tag which indicates that the conversion is performed to the converted packet. The transmitter 72 transmits the packet to the receiver 73. The receiver 73 receives the packet transmitted by the transmitter 72. When the packet including the conversion tag is detected, the receiver 73 converts the protocol of the packet into the protocol not including the retransmission function. As a result, communication between the transmitter 72 and the receiver 73 is performed by the protocol having the retransmission function.

In the second exemplary embodiment, communication quality is advantageously stabilized in the packet communication.

Reliability deterioration of communication using RTP mainly occurs when the packet passes an IP telephone network between a broadband access server on a transmitting side and one on receiving side. Because a communication between a residential gateway and a broadband access server is a communication between a user's premises and a communication equipment room, lack and/or delay of packets due to congestion with other communications hardly occur. In contrast, in an IP network, packets of other communications share network resource. Therefore, reliability of communication may deteriorate because of the lack and/or delay of packets during packet transmission.

The following are exemplary advantages according to the invention. In packet communication, because the protocol having the retransmission function is used, the durability on the lack and/or delay of the packet can improve. As a result, quality and reliability of communication can improve. In both of a data transmitting side and a data receiving side, a new function does not need to be added to equipment in a service user's residence. Therefore, cost to introduce the system of the present invention can be reduced.

While the invention has been particularly shown and described with reference to exemplary embodiments thereof, the invention is not limited to these exemplary embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

What is claimed is:

1. A communication system, comprising:
a transmitting unit transmitting a packet data, comprising:
a first detection unit receiving a packet data transmitted using a first protocol not including a retransmission function, detecting a predetermined bit pattern in said received packet data, and determining said packet data in which said bit pattern is detected is a target of protocol conversion; and
a first converting unit converting said first protocol of said determined packet data into a second protocol including a retransmission function, adding a conversion tag indicating execution of said protocol conversion to said converted packet data and transmitting said converted packet data including said conversion tag; and
a receiving unit receiving a packet data, comprising:
a second detection unit receiving said packet data which is transmitted using said second protocol and detecting said conversion tag in said packet data which is transmitted using said second protocol; and
a second converting unit converting said protocol of said packet data in which said conversion tag is detected into a third protocol.

2. The communication system according to claim 1, wherein said first protocol is identical with said third protocol.

3. The communication system according to claim 1, wherein
each of said first protocol and said third protocol is UDP (User Datagram Protocol),
said second protocol is TCP (Transmission Control Protocol), said packet data includes HDLC (High-level Data Link Control procedure) frame, and
said bit pattern is a flag sequence of said HDLC.

4. A communication method, comprising:
receiving a packet data transmitted using a first protocol not including a retransmission function;
detecting a predetermined bit pattern in said packet data received;
determining said packet data in which said bit pattern is detected is a target of protocol conversion;
converting said protocol of said determined packet data into a second protocol including a retransmission function;
adding a conversion tag indicating execution of said protocol conversion to said converted packet data and transmitting said converted packet data including said conversion tag;
receiving said packet data transmitted using said second protocol;
detecting said conversion tag in said packet data transmitted using said second protocol; and
converting said protocol of said packet data in which said conversion tag is detected into a third protocol.

5. The communication method according to claim 4, wherein said first protocol is identical with said third protocol.

6. The communication method according to claim 4, wherein
each of said first protocol and said third protocol is UDP (User Datagram Protocol),
said second protocol is TCP (Transmission Control Protocol), and
said bit pattern is a flag sequence of HDLC (High-level Data Link Control procedure).

7. A transmitting unit transmitting a packet data, comprising:
a detection unit receiving a packet data transmitted using a first protocol not including a retransmission function, detecting a predetermined bit pattern in said received packet data, and determining said packet data in which said bit pattern is detected is a target of protocol conversion; and
a converting unit converting said first protocol of said determined packet data into a second protocol including a retransmission function, adding a conversion tag indicating execution of said protocol conversion to said converted packet data and transmitting said converted packet data including said conversion tag.

8. The transmitting unit according to claim 7, wherein
said first protocol is UDP (User Datagram Protocol), said second protocol is TCP (Transmission Control Protocol),
said packet data includes HDLC (High-level Data Link Control procedure) frame, and
said bit pattern is a flag sequence of said HDLC.

9. A transmission method, comprising:
receiving a packet data transmitted using a first protocol not including a retransmission function;
detecting a predetermined bit pattern in said packet data received;
determining said packet data in which said bit pattern is detected is a target of protocol conversion;
converting said protocol of said determined packet data into a second protocol including a retransmission function; and
adding a conversion tag indicating execution of said protocol conversion to said converted packet data and transmitting said converted packet data including said conversion tag.

10. The transmission method according to claim 9, wherein
said first protocol is UDP (User Datagram Protocol),
said second protocol is TCP (Transmission Control Protocol), and
said bit pattern is a flag sequence of HDLC (High-level Data Link Control procedure).

11. A receiving unit receiving a packet data, comprising:
a detection unit receiving packet data which is transmitted using a first protocol including a retransmission function and detecting a conversion tag in said packet data which is transmitted using said first protocol; and
a converting unit converting said protocol of said packet data in which said conversion tag is detected into a second protocol not including a retransmission function.

12. The receiving unit according to claim 11, wherein
said first protocol is TCP (Transmission Control Protocol); and
said second protocol is UDP (User Datagram Protocol).

13. A receiving method, comprising:
receiving packet data transmitted using a first protocol including a retransmission function;
detecting a conversion tag in said packet data transmitted using said first protocol; and
converting said protocol of said packet data in which said conversion tag is detected into a second protocol not including a retransmission function.

14. The receiving method according to claim 13, wherein
said first protocol is TCP (Transmission Control Protocol) and
said second protocol is UDP (User Datagram Protocol).

15. A control program for executing a function of said transmitting unit according to claim 7 in a control unit thereof.

16. A recording medium which stores a control program operating a transmitting unit, wherein said control program comprises said control program according to claim 15.

17. A control program for executing a function of said receiving unit according to claim 11 in a control unit thereof.

18. A recording medium which stores a control program operating a receiving unit, wherein said control program comprises said control program according to claim 17.

19. A communication system, comprising:
a transmitting means for transmitting a packet data, comprising:
a first detection means for receiving a packet data transmitted using a first protocol not including a retransmission function, detecting a predetermined bit pattern in said received packet data, and determining said packet data in which said bit pattern is detected is a target of protocol conversion; and
a first converting means for converting said first protocol of said determined packet data into a second protocol including a retransmission function, adding a conversion tag indicating execution of said protocol conversion to said converted packet data and transmitting said converted packet data including said conversion tag; and
a receiving means for receiving a packet data, comprising:
a second detection means for receiving said packet data which is transmitted using said second protocol and detecting said conversion tag in said packet data which is transmitted using said second protocol; and
a second converting means for converting said protocol of said packet data in which said conversion tag is detected into a third protocol.

20. A transmitting means for transmitting a packet data, comprising:
a detection means for receiving a packet data transmitted using a first protocol not including a retransmission function, detecting a predetermined bit pattern in said received packet data, and determining said packet data in which said bit pattern is detected is a target of protocol conversion; and
a converting means for converting said first protocol of said determined packet data into a second protocol including a retransmission function, adding a conversion tag indicating execution of said protocol conversion to said converted packet data and transmitting said converted packet data including said conversion tag.

21. A receiving means for receiving a packet data, comprising:
a detection means for receiving packet data which is transmitted using a first protocol including a retransmission function and detecting a conversion tag in said packet data which is transmitted using said first protocol; and
a converting means for converting said protocol of said packet data in which said conversion tag is detected into a second protocol not including a retransmission function.
